(19) United States
(12) Patent Application Publication
(10) Pub. No.: US 2011/0090417 A1
(43) Pub. Date: Apr. 21, 2011

(54) LIQUID CRYSTAL DISPLAY WITH IMPROVED SIDE VISIBILITY AND FABRICATION METHOD THEREOF

(76) Inventors: Gee-Bum Kim, Yongin-city (KR); Jae-Hyun Kim, Yongin-city (KR); Yong-Kyu Jang, Yongin-city (KR)

(21) Appl. No.: 12/717,924

(22) Filed: Mar. 4, 2010

(30) Foreign Application Priority Data
Oct. 15, 2009 (KR) 10-2009-0098183

(51) Int. Cl. G02F 1/1368; G02F 1/13

(52) U.S. Cl. 349/42; 349/187

(57) ABSTRACT

In a liquid crystal display with improved side visibility and a fabrication method of the liquid crystal display, a unit pixel may include first and second sub-pixels in which liquid crystals are continuously aligned and electrically isolated. A first pixel electrode for implementing the first sub-pixel is formed on a protective layer. A second pixel electrode for implementing the second sub-pixel is formed beneath the protective layer. The protective layer formed on the second pixel electrode lowers the electric field of the second sub-pixel, so that a liquid crystal application voltage applied to the second sub-pixel is lower than the voltage applied to the first sub-pixel. Accordingly, the transmittances of the first and second sub-pixels in the unit pixel are different from each other to improve side visibility.

### CROSS-REFERENCE TO RELATED APPLICATION

This application claims priority to and the benefit of Korean Patent Application No. 10-2009-0098183, filed on Oct. 15, 2009, in the Korean Intellectual Property Office, the entire content of which is incorporated herein by reference.

### BACKGROUND

1. Field

Non-limiting example embodiments of the present invention relate to a liquid crystal display (LCD) and a fabrication method thereof, and more particularly, to an LCD having improved side visibility and a fabrication method thereof.

2. Description of Related Art

In general, a liquid crystal display (LCD) is a display that displays images by controlling transmittance of light incident from a light source, using the optical anisotropy of liquid crystal molecules and the polarization property of a polarizing plate. Because of light, thin, high-resolution and large-size characteristics of LCDs, their application fields have been rapidly extended.

However, because images are displayed by transmitting light only to the light transmission axis of liquid crystal molecules, such LCDs have a narrower viewing angle that those of other displays.

Therefore, various technologies for improving the viewing angle have been developed such as, a patterned vertical alignment (PVA) mode. In the PVA mode, liquid crystal molecules are aligned vertically to upper and lower substrates, and cut-away patterns are formed at a pixel electrode and a common electrode opposite to the pixel electrode, respectively. Therefore, a plurality of multi domains are formed by distorting the electric field formed between the two electrodes.

However, like the PVA mode LCD, a vertical alignment type LCD has lower side visibility than front visibility. For example, in a PVA mode LCD having cut-away portions, a gamma characteristic is seriously distorted as viewed further away from the center to the front side, and in the worst case, the difference in luminance between high grayscales disappears. Therefore, the image may get distorted.

To solve such a problem, a method has been proposed in which, one pixel is divided into two sub-pixels, and a total storage capacitance is graded so that a high voltage is applied to a sub-pixel having a large storage capacitance and a low voltage is applied to a sub-pixel having a small storage capacitance, resulting in different transmittances.

However, when this method of dividing one unit pixel into two sub-pixels is applied to a high-resolution (e.g., 250 PPI or higher) LCD, the aperture ratio is considerably lowered. Therefore, it is difficult to practically apply the method to the high resolution LCD.

### SUMMARY

Non-limiting example embodiments of the present invention are directed to a liquid crystal display (LCD) capable of improving side visibility and a fabrication method thereof.

According to some non-limiting example embodiments of the present invention, an LCD may include a unit pixel including gate lines and data lines overlapping with the gate lines and providing electric signals to the unit pixel, a thin film transistor formed in the unit pixel, a storage electrode connected to a drain electrode of the thin film transistor, the storage electrode being formed in a region of the unit pixel. Also, a second pixel electrode is electrically coupled to one side of the storage electrode, in a first region in the unit pixel, the second pixel electrode implementing a second sub-pixel, a protective layer in the region of the unit pixel may include the storage electrode and the second pixel electrode, the protective layer may include a contact hole formed in a region thereof overlapping with a portion of the storage electrode, and a first pixel electrode formed in a second region of the unit pixel including the contact hole, the first pixel electrode implementing a first sub-pixel

The LCD may further include a storage line extending through the unit pixel. The storage line may be formed in the same layer as the gate lines.

In one non-limiting example embodiment, the storage electrode may be formed in the same layer as the data lines, and the first and second pixel electrodes are electrically connected to the storage electrode.

The protective layer may be formed from a silicon nitride, a silicon oxide or a stacked layer of the silicon nitride and the silicon oxide.

In one non-limiting example embodiment, the contact hole may be formed at a central portion of the unit pixel, and an anchoring force of liquid crystals positioned in the contact hole controls the operations of liquid crystal molecules.

In some non-limiting example embodiments, the first and second pixel electrodes may be respectively formed in two non-overlapping regions, and the area ratio of the first pixel electrode to the second pixel electrode may be in the range of about 1:3 to about 1:2.

According to some non-limiting example embodiments of the present invention, a fabrication method of an LCD including a plurality of unit pixels including gate lines and data lines intersecting with the gate lines and providing electric signals to the unit pixels is provided. Specifically, a second pixel electrode may be formed in contact with one side of a storage electrode in a second region of each of the plurality of unit pixels on a transparent substrate on which, a thin film transistor and the storage electrode are formed for each of the plurality of unit pixels, a protective layer may be formed on the transparent substrate, a contact hole may be formed in the protective layer in a region overlapping with the storage electrode to expose a portion of the storage electrode, and a first pixel electrode may be formed in a first region of the unit pixel including the contact hole.

According to some non-limiting example embodiments of the present invention, a fabrication method of an LCD including a plurality of unit pixels including gate lines and data lines intersecting with the gate lines and providing electric signals to the unit pixels is provided. The fabrication method may include forming a second sub-pixel for each of the plurality of unit pixels including a second pixel electrode in contact with one side of a storage electrode in a second region of each of the plurality of unit pixels on a transparent substrate on which, a thin film transistor and the storage electrode may be formed for each of the plurality of unit pixels, forming a protective layer on the transparent substrate, forming a contact hole in the protective layer in a region overlapping with the storage electrode to expose a portion of the storage electrode, forming a first sub-pixel for each of the plurality of unit pixels including a first pixel electrode in a first region of each of the plurality of the unit pixel including the contact hole and excluding the second region, and forming an electrical contact from the first pixel electrode to the storage electrode, via the contact hole.

In some non-limiting example embodiments, the second pixel electrode may be formed to overlap with the one side of the storage electrode in the second region.

According to non-limiting example embodiments of the present invention, when a unit pixel may be divided into first and second sub-pixels, the first and second sub-pixels may be in electrical contact with each other, but a protective layer may be formed on a second pixel electrode for implementing the second sub-pixel, so that the electric field of the second sub-pixel may be lowered. Therefore, a liquid crystal application voltage applied to the second sub-pixel may be lower than that applied to the first sub-pixel. Accordingly, a vertical-alignment LCD may have improved side visibility without lowering an aperture ratio.

### BRIEF DESCRIPTION OF THE DRAWINGS

The accompanying drawings, together with the specification, illustrate non-limiting example embodiments of the present invention, and, together with the description, serve to explain the principles of the present invention.

FIG. 1 is a plan view illustrating a unit pixel of a liquid crystal display (LCD) according to some non-limiting example embodiments of the present invention.

FIGS. 2A and 2B are sectional views taken along lines I-I′ and II-II′ of FIG. 1, respectively.

FIG. 3 is a sectional view conceptually illustrating the driving of the LCD illustrated in FIG. 1.

FIGS. 4A to 4D are sectional views illustrating a method of manufacturing an LCD according to a non-limiting example embodiment of the present invention.

### DETAILED DESCRIPTION

In the following detailed description, only certain non-limiting example embodiments of the present invention have been shown and described, simply by way of illustration. As those skilled in the art would realize, the described non-limiting example embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements located therebetween. Also, when an element is referred to as being “connected to” another element, it can be directly connected to the other element or be indirectly connected to the other element with one or more intervening elements located therebetween. Hereinafter, like reference numerals refer to like elements.

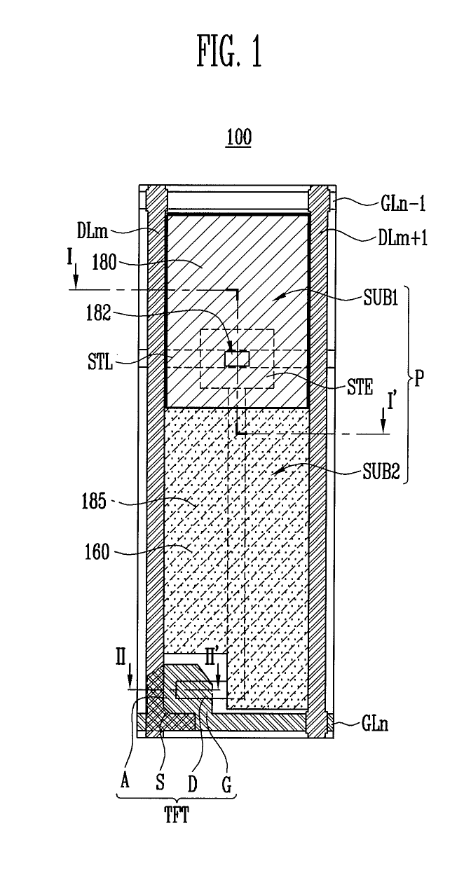

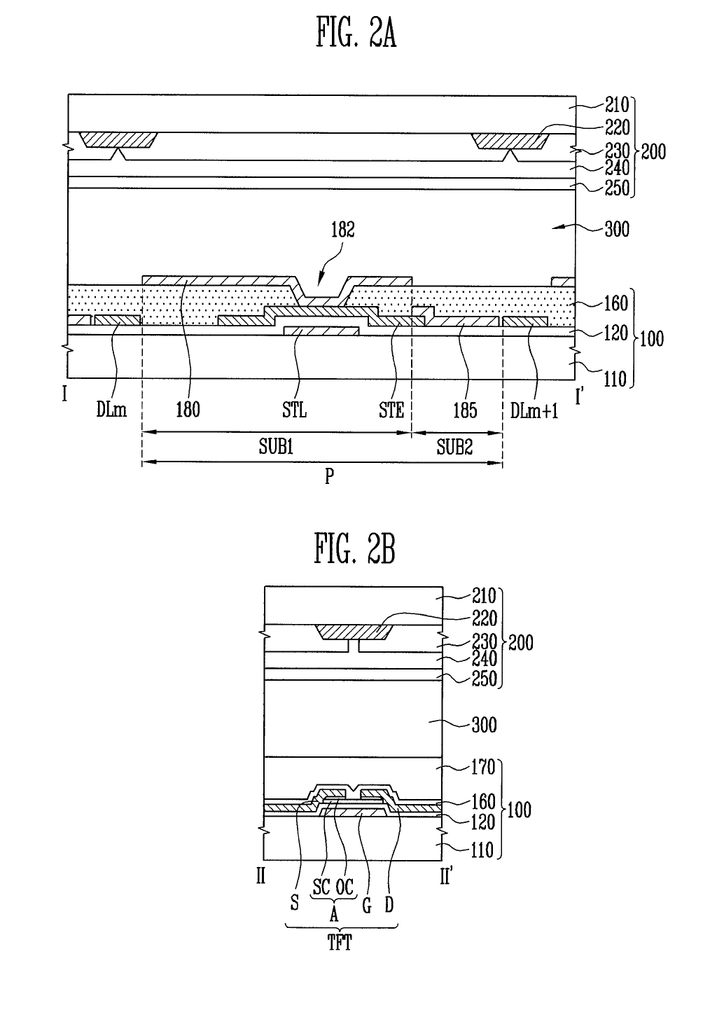

FIG. 1 is a plan view illustrating a unit pixel of a liquid crystal display (LCD) according to some non-limiting example embodiments of the present invention. FIGS. 2A and 2B are sectional views taken along lines I-I′ and II-II′ of FIG. 1, respectively.

Specifically, FIG. 2A is a sectional view illustrating a region including a storage line extending through the unit pixel, and FIG. 2B is a sectional view illustrating a region at which a thin film transistor is formed in the unit pixel.

Referring to FIGS. 1, 2A and 2B, the LCD may include a first substrate 100, a second substrate 200 and a liquid crystal layer 300 located between the first and second substrates 100 and 200.

The first substrate 100 may include a transparent substrate 110, gate lines GLn−1, GLn, . . . , data lines DLm, DLm+1, . . . , a thin film transistor TFT, a protective layer 160, first and second pixel electrodes 180 and 185, a storage line STL, and a storage capacitor Cst (not explicitly shown) formed by a storage electrode STE.

The gate lines GLn−1, GLn, . . . may extend in a first direction (X) on the transparent substrate 110. The gate lines GLn−1, GLn, . . . may be first metal patterns formed by patterning a first metal layer.

A gate insulating layer 120 may be formed on the transparent substrate 110 on which the gate lines GLn−1, GLn, . . . are formed. The gate insulating layer 120 may include a silicon nitride (SiNx), for example.

The data lines DLm, DLm+1, . . . extending in a second direction (Y) substantially perpendicular to the first direction (X) may be formed on the gate insulating layer 120.

In some non-limiting example embodiments, the data lines DLm, DLm+1, . . . may be second metal patterns formed by patterning a second metal layer. Unit pixels P arranged in a matrix form may include the data lines DLm, DLm+1, . . . and the gate lines GLn−1, GLn, . . . intersecting with one another on the transparent substrate 110. For example, the data lines DLm, DLm+1, . . . and the gate lines GLn−1, GLn may be employed to define the unit pixels. However, the unit pixel may not be defined by the data lines DLm, DLm+1, . . . and the gate lines GLn−1, GLn. The data lines DLm, DLm+1, . . . and the gate lines GLn−1, GLn, . . . included in the unit pixel may provide electric signal with the unit cell. The electric signal may be required for operating the unit cell.

Hereinafter, a unit pixel P including an n-th gate line GLn and an m-th data line DLm overlapping with each other will be described in detail.

The unit pixel P may include a thin film transistor TFT, a protective layer 160, first and second pixel electrodes 180 and 185, a storage line STL and a storage electrode STE.

The thin film transistor TFT may be formed at an intersection portion of the n-th gate line GLn and the m-th data line DLm, and may include a gate electrode G, an active layer A, a source electrode S and a drain electrode D.

The gate electrode G may be a first metal pattern protruding from the n-th gate line GLn. The gate insulating layer 120 may be formed on the gate electrode G, and the active layer A overlapping with the gate electrode G may be formed on the gate insulating layer 120.

The active layer A may be formed into a structure in which a semiconductor layer SC and an ohmic contact layer OC may be stacked. For example, in some non-limiting example embodiments, the semiconductor layer SC may be formed using an amorphous silicon (a—Si:H), and the ohmic contact layer may be formed using an amorphous silicon (n+a-Si:H) heavily doped with an n-type impurity.

The source and drain electrodes S and D formed using a second metal pattern substantially the same as that of the data lines DLm, DLm+1, . . . may be formed on the active layer A.

The source electrode S may protrude from the m-th data line DLm and partially overlap with the active layer A. The drain electrode D may be formed to be spaced apart from the source electrode S at a predetermined interval, and partially overlap with the active layer A.

Subsequently, the ohmic contact layer OC may be removed in the spacing portion of the source and drain electrodes S and D, and the semiconductor layer SC may be exposed.

The thin film transistor TFT may be a switching element that may apply a data voltage to the pixel electrode 180 in response to a timing signal applied from the gate electrode G.

In the non-limiting example embodiment illustrated in FIGS. 1 and 2, a thin film transistor TFT may be provided to each of the unit pixels P may be formed into a bottom gate structure in which an active layer may be formed using amorphous silicon. However, the present invention may not be limited thereto. That is, the thin film transistor TFT may be formed into a top gate structure in which the active layer is formed using crystalline silicon.

As illustrated in FIG. 2A, the first and second pixel electrodes 180 and 185 may be formed in a region of the unit pixel P including the gate and data lines. Each of the first and second pixel electrodes 180 and 185 may be electrically connected to the storage electrode STE.

More specifically, the first pixel electrode 180 may make in contact with the storage electrode STE through a contact hole 182 formed in one region of the unit pixel P overlapping with the storage line STL, and the second pixel electrode 185 may come in direct contact with one side of the storage electrode STE.

In the non-limiting example embodiment of the present invention, the first and second pixel electrodes 180 and 185 may be formed in two regions into which the region of the unit pixel P may cut through different processes, respectively. Accordingly, the unit pixel P may include a first sub-pixel SUB1 implemented by the first pixel electrode 180 and a second sub-pixel SUB2 implemented by the second pixel electrode 185.

Also, the first and second pixel electrodes 180 and 185 may be electrically connected to the storage electrode STE as described above, and the storage electrode STE may be electrically connected to the drain electrode D of the thin film transistor TFT. Therefore, the same data voltage may be applied to the first and second pixel electrodes 180 and 185 constituting the unit pixel P.

As illustrated in FIG. 1, the storage electrode STE may be formed in a region overlapping with the storage line STL in the unit pixel. The storage electrode STE may be formed in the same layer together with the drain electrode D of the thin film transistor TFT and electrically connected to the drain electrode D. For example, the storage electrode STE and the drain electrode D may be formed using the same metallic material. However, the present invention may not be necessarily limited thereto.

The storage line STL may be formed in the same layer together with the gate lines GLn−1, GLn, . . . , and extend in the first direction (X) through the unit pixel P, as illustrated in FIG. 1. Here, the storage line STL and the gate lines may be formed using the same metallic material. However, the present invention may be not necessarily limited thereto.

The storage electrode STE may be a metal pattern electrically connected to the drain electrode D. The storage electrode STE may overlap with the storage line STL in each of the unit pixels P to form storage capacitance of each of the unit pixels P.

That is, the storage electrode STE and the storage line STL may overlap with each other with the gate insulating layer 120 located between the storage electrode STE and the storage line STL to form a storage capacitor Cst charged with a data voltage during one frame.

After the storage electrode STE may be formed, the second pixel electrode 185 may be formed to make in contact with one side of the storage electrode STE on a region in the unit pixel P.

Furthermore, the protective layer 160 may be formed on the transparent substrate 110 on which the thin film transistor TFT, the storage capacitor Cst and the second pixel electrode 185 may be formed. The contact hole 182 may be formed in the region of the protective layer 160 overlapping a portion of with the storage electrode STE, so that the portion of the storage electrode STE may be exposed.

In some non-limiting example embodiments, the protective layer 160 may be formed using a silicon nitride (SiNx), a silicon oxide (SiO₂) or a stacked layer of the silicon nitride (SiNx) and the silicon oxide (SiO₂).

Because a portion of the storage electrode STE may be exposed by the contact hole 182 formed in the protective layer 160, the first pixel electrode 180 may be formed in the other region of the unit pixel P, which may include the contact hole 182.

Here, the first and second pixel electrodes 180 and 185 may be respectively formed in two non-overlapping regions into which the unit pixel P may be divided.

The area ratio of the first pixel electrode 180 to the second pixel electrode 185 may be in the range of about 1:3 to about 1:2, according to some non-limiting example embodiments of the present invention.

That is, the unit pixel P may include a first sub-pixel SUB1 defined as a region where the first pixel electrode 180 is formed and a second sub-pixel SUB2 defined as the other non-overlapping region where the second pixel electrode 185 is formed. The first pixel electrode 180 may make in electrical contact with the storage electrode STE through the contact hole 182, and the second pixel electrode 185 may make in direct contact with one side of the storage electrode STE.

According to some non-limiting example embodiments of the present invention, the protective layer 160 may be formed on an upper region of the second pixel electrode 185. In this case, the second protective layer 162 formed on the upper region of the second pixel electrode 185 lowers the electric field of the second sub-pixel SUB2 so that the liquid crystal application voltage applied to the region of the second sub-pixel SUB2 may be lower than that applied to the region of the first sub-pixel SUB1 with respect to the data voltage uniformly applied to the unit pixels P.

In some non-limiting example embodiments, the first and second pixel electrodes 180 and 185 may be formed using a transparent conductive material. For example, the first and second pixel electrodes 180 and 185 may be formed using indium tin oxide (ITO), indium zinc oxide (IZO), or the like.

The second substrate 200 making in surface contact with the first substrate 100 to be substantially opposite to the first and second pixel electrodes 180 and 185 may include a transparent substrate 210, a black matrix 220, a color filter 230 and a common electrode 250.

The black matrix 220 may be formed on a surface of the transparent substrate 210 substantially opposite to the first substrate 100. In some non-limiting example embodiments, the black matrix 220 may be formed to correspond to the gate and data lines formed on the first substrate 100. Thus, the black matrix 220 may prevent light from leaking between the unit pixels.

The color filter 230 may include, for example, red, green and blue filters formed on the transparent substrate 210, corresponding to the respective unit pixels P. The color filter 230 and the black matrix 220 may partially overlap with each other.

In some non-limiting example embodiments, the second substrate 200 may further include an overcoat layer 240 formed on the color filter 230. The overcoat layer 240 may provide the transparent substrate 201 on which the black matrix 220 and the color filter 230 are formed with a substantially flat surface.

The common electrode 250 may be formed on the overcoat layer 240, corresponding to the entire surface of the second substrate 200.

In some non-limiting example embodiments, the common electrode 250 may be formed using a transparent conductive material. For example, the common electrode 250 may be formed using ITO, IZO or the like.

A contact hole (not shown) may be formed in the region corresponding to the contact hole 182 formed in the unit pixel P on the first substrate 100.

The storage line STL and the storage electrode STE may be formed at a constant area ratio in the unit pixel P to form a storage capacitor Cst charged with the data voltage. However, when the storage line STL and the storage electrode STE may be formed using an opaque metallic material, the storage line STL and the storage electrode STE may shield light, thereby resulting in a low aperture ratio of the unit pixel P.

When the LCD may be driven, liquid crystal molecules may be aligned at an angle at which light may be not emitted by allowing the liquid crystal molecules to collide with each other in a region corresponding to the contact hole 182, and hence a singular point may be formed, at which light may be not emitted. Therefore, the contact hole 182 may be a factor that causes the aperture ratio of the unit pixel P to be lowered.

Accordingly, the storage line STL, the storage electrode STE and the contact hole 182, which may be among factors that cause the aperture of the unit pixel P to be lowered, may be formed to overlap with one another, to prevent the aperture ratio of the unit pixel P from being lowered.

The storage line STL and the storage electrode STE, forming the storage capacitor Cst, may be formed using a transparent conductive material, thereby preventing the lowering of the aperture ratio.

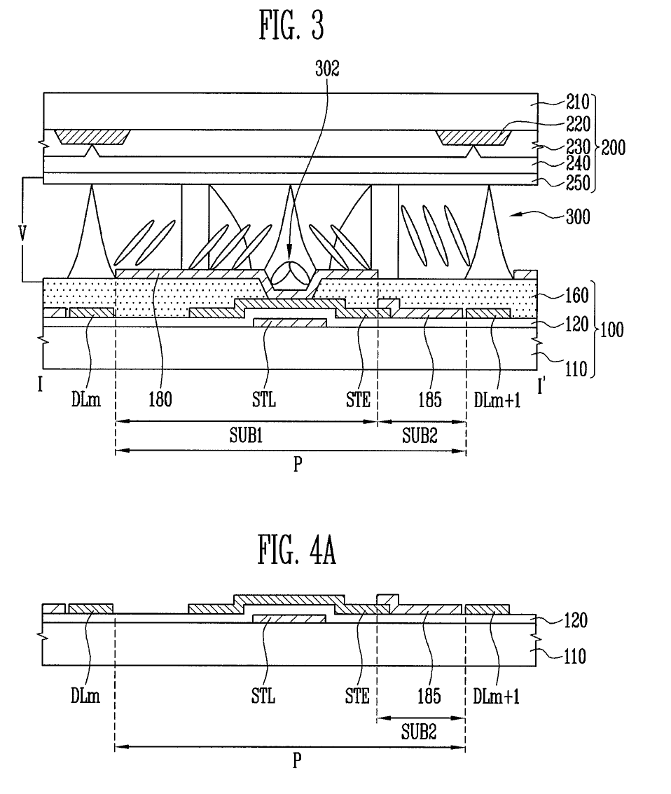

FIG. 3 is a sectional view conceptually illustrating the driving of the LCD illustrated in FIG. 1. Here, the driving of the LCD will be described using the sectional region of FIG. 2A.

Referring to FIG. 3, when voltage may not be applied to the first and second pixel electrodes 180 and 185 and the common electrode 250, an electric field may not be generated between the first and second substrates 100 and 200. In this case, liquid crystal molecules in the liquid crystal layer 300 may be in a substantially vertical alignment state. Therefore, although light may be provided from the rear of the LCD panel, the light may not advance through the liquid crystal layer 300.

On the other hand, when a voltage V may be applied to the first and second pixel electrodes 180 and 185 and the common electrode 250, electric field lines may be formed in a substantially diagonal direction in the vicinity of the contact hole 182, and liquid crystal molecules adjacent to the electric field lines rapidly respond first. Accordingly, the liquid crystal molecules may be realigned in a direction substantially vertical or substantially parallel to the electric field lines in the vicinity of the contact hole 182, so that light advances through the liquid crystal layer 300.

That is, the LCD of the present invention controls operations of liquid crystal molecules using an anchoring force of liquid crystals 302 positioned in the contact hole 182 formed at the central portion of the unit pixel P.

Similarly, as illustrated in FIG. 3, electric field lines may be also formed in a substantial diagonal direction in an edge region of the unit pixel P, and liquid crystal molecules adjacent to the electric field lines rapidly respond first. Accordingly, the liquid crystal molecules may be realigned in a direction substantially vertical or substantially parallel to the electric field lines in the edge region of the unit pixel P, so that light may advances through the liquid crystal layer 300.

However, liquid crystal molecules positioned in a middle area between the contact hole 182 and the edge region may not be relatively influenced by the electric field lines. Thus, the response speed may be lowered, thereby resulting in lowering of side visibility.

To solve such a problem, the protective layer 160 may be formed in the upper region of the second pixel electrode 185 with respect to the region of the second sub-pixel SUB2 to serve as an electric-field reducing layer, as illustrated in FIG. 3. Accordingly, transmittances may be respectively applied to the two sub-pixels SUB1 and SUB2 constituting the unit pixel P to prevent side visibility from being lowered.

Here, the region where the first pixel electrode 180 is formed may become the first sub-pixel SUB1, and the region where the second pixel electrode 185 is formed may become the second sub-pixel SUB2.

In the related art, when the unit pixel P may be divided into a plurality of sub-pixels, individual thin film transistors and storage capacitors may be respectively used in the sub-pixels by electrically isolating the sub-pixels from one another. However, in the non-limiting example embodiments of the present invention, the first and second sub-pixels SUB1 and SUB2 may be electrically connected to each other, and the same thin film transistor TFT and storage capacitor Cst may be used in the first and second sub-pixels SUB1 and SUB2.

Accordingly, a high-resolution (e.g., 250 PPI or higher) LCD may have a relatively improved side visibility without lowering an aperture ratio.

In some non-limiting example embodiments, polymer stabilized liquid crystals (PSLCs) may be applied to improve a liquid crystal control force and response speed and bruising properties in the contact hole 182.

More specifically, because a data voltage substantially the same as that applied to the first sub-pixel SUB1, in which the protective layer 160 may be formed beneath the first pixel electrode 180, may be applied to the protective layer 160 formed on the second pixel electrode 185, the protective layer 160 may serve as a dielectric substance added to a liquid crystal capacitor. Therefore, the liquid crystal application voltage applied to the second sub-pixel SUB2 may be lower than that of the first sub-pixel SUB1.

As described above, as the liquid crystal application voltages of the first and second sub-pixels SUB1 and SUB2 may be substantially different in the same data signal, the liquid crystals may be aligned so that the light may be transmitted in various directions. Accordingly, light incident from the rear of the LCD panel may be emitted in various directions, thereby widening a viewing angle and improving side visibility.

In other words, the unit pixel P may include first and second sub-pixels SUB1 and SUB2 in which liquid crystals may be continuously aligned without their electrical isolation, and the protection layer 160 may be formed on the pixel electrode 180 for implementing the second sub-pixel SUB2, so that the liquid crystal application voltage applied to the region of the second sub-pixel SUB2 may be lower than that applied to the region of the first sub-pixel SUB1. Accordingly, the transmittances of the first and second sub-pixels SUB1 and SUB2 in the unit pixel P may be substantially different from each other, thereby improving side visibility.

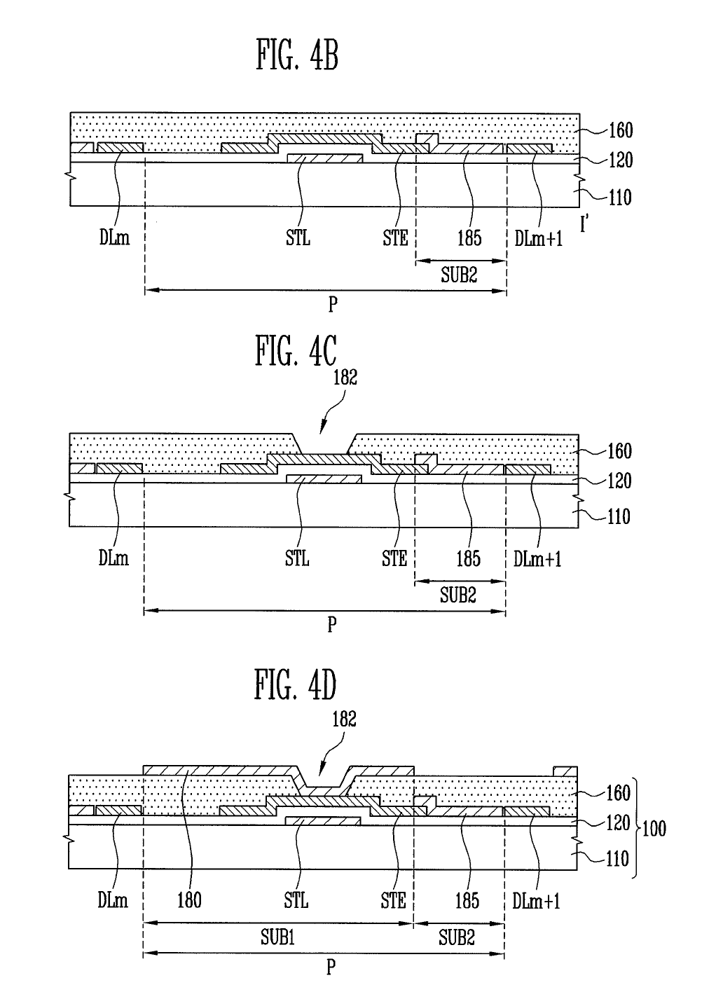

FIGS. 4A to 4D are sectional views illustrating a method of manufacturing an LCD according to a non-limiting example embodiment of the present invention. For convenience of illustration, a method of manufacturing the first substrate illustrated in FIG. 2A will be described with reference to the sectional views.

Referring to FIG. 4A, a second pixel electrode 185 may be formed to make in contact with one side of a storage electrode STE on one region in a unit pixel P, with respective to a transparent substrate 110 on which a thin film transistor (not shown), a storage line STL, a gate insulating layer 120 and the storage electrode STE may be formed.

Referring to FIG. 4B, a protective layer 160 may be formed on the transparent substrate 110 on which the thin film transistor TFT, the storage capacitor Cst and the second pixel electrode 185 may be formed. In some non-limiting example embodiments, the protective layer 160 may be formed using a silicon nitride (SiNx), a silicon oxide (SiO₂) or a stacked layer of the silicon nitride (SiNx) and the silicon oxide (SiO₂).

Referring to FIG. 4C, a contact hole 182 may be formed in a region of the protective layer 160 overlapping with the storage electrode STE, so that a portion of the storage electrode STE may be exposed. Referring to FIG. 4D, a first pixel electrode 180 may be formed in another region of the unit pixel P having the contact hole 182, so that the first pixel electrode 180 may be electrically connected to the storage electrode STE.

As a result, the first and second pixel electrodes 180 and 185 may be respectively formed in two regions into which the unit pixel may be divided not to overlap with each other. In some non-limiting example embodiments, the area ratio of the first pixel electrode 180 to the second pixel electrode 185 may be in the range of about 1:3 to about 1:2.

That is, the unit pixel P may include a first sub-pixel SUB1 that may be a region where the first pixel electrode 180 formed and a second sub-pixel SUB2 where the second pixel electrode 185 is formed. The first pixel electrode 180 may make in contact with the storage electrode STE through the contact hole 182, and the second pixel electrode 185 may make in direct contact with one side of the storage electrode STE.

Additionally, the protective layer 160 may be formed on an upper region of the second pixel electrode 185. With this structure, the protective layer 160 formed on the upper region of the second pixel electrode 185 may lower the electric field of the second sub-pixel SUB2 so that the liquid crystal application voltage applied to the region of the second sub-pixel SUB2 may be lower than that applied to the region of the first sub-pixel SUB1 with respect to the data voltage uniformly applied to the unit pixels P.

In some non-limiting example embodiments, the first and second pixel electrodes 180 and 185 may be formed using a transparent conductive material. For example, the first and second pixel electrodes 180 and 185 may be formed using ITO, IZO, or the like.

While the present invention has been described in connection with certain non-limiting example embodiments, it may be to be understood that the invention may be not limited to the disclosed non-limiting example embodiments, but, on the contrary, may be intended to cover various modifications and equivalent arrangements included within the spirit and scope of the appended claims, and equivalents thereof.

What is claimed is:

1. A liquid crystal display (LCD) comprising:
a unit pixel including gate lines and data lines overlapping with the gate lines and providing electric signals with the unit pixel;
a thin film transistor in the unit pixel;
a storage electrode connected to a drain electrode of the thin film transistor, the storage electrode being formed in a region of the unit pixel;
a second pixel electrode electrically coupled to one side of the storage electrode, in a first region in the unit pixel, the second pixel electrode implementing a second sub-pixel;
a protective layer in the region of the unit pixel having the storage electrode and the second pixel electrode, the protective layer having a contact hole formed in a region thereof overlapping with a portion of the storage electrode; and
a first pixel electrode formed in a second region of the unit pixel including the contact hole, the first pixel electrode implementing a first sub-pixel.

2. The LCD according to claim 1, further comprising a storage line extending through the unit pixel,
wherein the storage line is formed in a same layer as the gate lines.

3. The LCD according to claim 1, wherein the storage electrode is in a same layer as the data lines.

4. The LCD according to claim 1, wherein the first and second pixel electrodes are electrically coupled to the storage electrode.

5. The LCD according to claim 1, wherein the protective layer is formed from a silicon nitride, a silicon oxide, or a stacked layer of the silicon nitride and the silicon oxide.

6. The LCD according to claim 1, wherein the contact hole is formed at a central portion of the unit pixel, and an anchoring force of liquid crystals positioned in the contact hole controls operations of liquid crystal molecules.

7. The LCD according to claim 6, wherein the liquid crystals are polymer stabilized liquid crystals.

8. The LCD according to claim 1, wherein the first and second pixel electrodes are respectively formed in two non-overlapping regions into which the unit pixel is divided so as not to overlap with each other.

9. The LCD according to claim 8, wherein an area ratio of the first pixel electrode to the second pixel electrode is in the range of about 1:3 to about 1:2.

10. A fabrication method for an LCD having a plurality of unit pixels including gate lines and data lines overlapping with the gate lines and providing electric signals to the unit pixels, the method comprising:
forming a second pixel electrode in contact with one side of a storage electrode in a second region of each of the plurality of unit pixels on a transparent substrate on which, a thin film transistor and the storage electrode are formed for each of the plurality of unit pixels;
forming a protective layer on the transparent substrate;
forming a contact hole in the protective layer in a region overlapping with the storage electrode to expose a portion of the storage electrode; and
forming a first pixel electrode in a first region of the unit pixel including the contact hole.

11. The method according to claim 10, wherein the first pixel electrode implements a first sub-pixel of the unit pixel, and the second pixel electrode implements a second sub-pixel of the unit pixel.

12. The method according to claim 10, wherein the first region of the unit pixel is non-overlapping with the second region of the unit pixel.

13. The method according to claim 12, wherein an area ratio of the first pixel electrode to the second pixel electrode is in the range of about 1:3 to about 1:2.

14. The method according to claim 10, wherein the liquid crystals are polymer stabilized liquid crystals.

15. The method according to claim 10, wherein the second pixel electrode is formed to overlap with the one side of the storage electrode in the second region.

16. A fabrication method for an LCD having a plurality of unit pixels including gate lines and data lines overlapping with the gate lines and providing electric signals to the unit pixel, the method comprising:
forming a second sub-pixel for each of the plurality of unit pixels including a second pixel electrode in contact with one side of a storage electrode in a second region of each of the plurality of unit pixels on a transparent substrate on which, a thin film transistor and the storage electrode are formed for each of the plurality of unit pixels;
forming a protective layer on the transparent substrate;
forming a contact hole in the protective layer in a region overlapping with the storage electrode to expose a portion of the storage electrode;
forming a first sub-pixel for each of the plurality of unit pixels including a first pixel electrode in a first region of each of the plurality of the unit pixel including the contact hole and excluding the second region; and
forming an electrical contact from the first pixel electrode to the storage electrode, via the contact hole.

17. The method according to claim 16, wherein an area ratio of the first pixel electrode to the second pixel electrode is in the range of about 1:3 to about 1:2.

18. The method according to claim 16, wherein the liquid crystals are polymer stabilized liquid crystals.

19. The method according to claim 16, wherein the second pixel electrode is formed to overlap with the one side of the storage electrode in the second region.
